(19) United States
(12) Patent Application Publication
(10) Pub. No.: US 2015/0280207 A1
(43) Pub. Date: Oct. 1, 2015

(54) METHOD OF PREPARING GRAPHENE-GRAPHENE FUSED MATERIAL AND METHOD OF PREPARING GRAPHENE-SUBSTRATE COMPOSITE USING THE SAME

(71) Applicant: Nano Cast Tech Co., Ltd., Seoul (KR)

(72) Inventors: Jae Woo CHUNG, Seoul (KR); Jung Hyun KIM, Seoul (KR)

(73) Assignee: NANO CAST TECH Co., Ltd., Seoul (KR)

(21) Appl. No.: 14/225,539

(22) Filed: Mar. 26, 2014

(51) Int. Cl. H01M 4/04; H01M 4/62

(52) U.S. Cl. CPC H01M 4/0416; H01M 4/625

(57) ABSTRACT

The present invention relates to a method of preparing a graphene-substrate composite using a graphene-graphene fused material. The method of preparing a graphene-substrate composite includes (a) forming a nano graphene-metal fused material comprised of nano-graphene and nano metal, (b) thermally treating the plurality of nano graphene-metal fused materials at a temperature higher than a melting point of the nano metal to connect the plurality of nano graphene-metal fused materials to each other by a melting bonding of the nano metal to form a graphene-graphene fused material, (c) pulverizing the graphene-graphene fused material to form a graphene-graphene fused material powder, and (d) dispersing the graphene-graphene fused material powder in a substrate to form a graphene-substrate composite.

### BACKGROUND

1. Field

The present invention relates to a method of preparing a graphene-graphene fused material and a method of preparing a graphene-substrate composite, and more particularly, to a method of preparing a graphene-graphene fused material in which graphenes are fused via a nano metal, and a method of preparing a graphene-substrate composite in which the graphene-graphene fused material is pulverized and mixed and dispersed in a substrate to enhance the electrical conductivity.

2. Description of the Related Art

Graphene is a 2-dimensional nano sheet having a honeycomb lattice made of sp2-bonded carbon atoms, and has a high usability as a negative electrode active material of a lithium secondary battery and an electrode active material of an ultra high capacity capacitor due to a high specific surface area and superior electrical conductivity and mechanical strength. FIG. 1 is a structural view illustrating a 2-D nanosheet of single layer graphene. As illustrated in FIG. 1, the graphene is made of a 2-dimensional single layer nanosheet. Such graphene has drastically come to the fore as a core material of the material industry.

For application of graphene to a large-sized graphene sheet, a preparation method using a chemical vapor deposition process has been proposed, but has a problem in that the large-sized graphene sheet may be formed only on a copper substrate.

Meanwhile, when a functional group is made such that nano graphene is well mixed with other substrates, a composite using a nano graphene powder may be used in many applications, such as ultra light weight and ultra high conductive materials, heat conduction sheets, electrically conductive polymers, and the like. Thus, it is important to make various kinds of functional groups, such as COOH, COO, OH, NH, or the like on corners of nano graphene according to materials mixed together with nano graphene. FIG. 2 schematically illustrates such a state. In the existing techniques, the process of making functional groups on corners of nano graphene is conducted in a liquid, such as acid or alkali as described above, but increases subsequent processes to deteriorate the economic feasibility and the productivity.

Also, in most existing graphene composites, since graphene molecules dispersed on a substrate and thus connection between graphenes is not good, the existing graphene composites have a problem in that the performances of electrical conductivity, heat conductivity, gas barrier and the like are not excellent.

### SUMMARY

To accomplish the above-mentioned technical object, the present invention provides a method of preparing a graphene-graphene fused material in which graphenes having superior electrical conductivity are fused via a nano metal.

The present invention also provides a graphene-substrate composite having superior electrical conductivity in which the graphene-graphene fused material is pulverized and is then dispersed in the substrate.

To accomplish the above-described technical objects, a method of preparing a graphene-graphene fused material includes (a) forming a nano graphene-metal fused material comprised of nano-graphene and nano metal, and (b) thermally treating the plurality of nano graphene-metal fused materials at a temperature higher than a melting point of the nano metal to connect the plurality of nano graphene-metal fused materials to each other by a melting bonding of the nano metal to form a graphene-graphene fused material.

In the method of preparing a graphene-graphene fused material according to the above-described first feature, the nano graphene-metal fused material is preferably formed by coating or attaching nano metal particles on a surface of the nano graphene.

In the method of preparing a graphene-graphene fused material according to the above-described first feature, the graphene-graphene fused material is preferably configured in the form of a single chain in which the plurality of nano graphene-metal fused materials are sequentially connected, or in the form of a composite chain in which the plurality of nano graphene-metal fused materials are irregularly connected.

In the method of preparing a graphene-graphene fused material according to the above-described first feature, the thermal treating of the graphene-metal fused material is preferably conducted at a temperature higher than a melting point of the nano metal.

In the method of preparing a graphene-graphene fused material according to the above-described first feature, the nano metal is preferably any one of nickel, copper and silver.

The method of preparing a graphene-substrate composite according to a second feature of the present invention includes (a) forming a nano graphene-metal fused material comprised of nano-graphene and nano metal, (b) thermally treating the plurality of nano graphene-metal fused materials at a temperature higher than a melting point of the nano metal to connect the plurality of nano graphene-metal fused materials to each other by a melting bonding of the nano metal to form a graphene-graphene fused material, (c) pulverizing the graphene-graphene fused material to form a graphene-graphene fused material powder, and (d) dispersing the graphene-graphene fused material powder in a substrate to form a graphene-substrate composite.

In the method of preparing a graphene-substrate composite using the graphene-graphene fused material according to the above-described second feature, the nano graphene-metal fused material is preferably formed by coating or attaching nano metal particles on a surface of the nano graphene.

In the method of preparing a graphene-substrate composite using the graphene-graphene fused material according to the above-described second feature, the graphene-graphene fused material is preferably configured in the form of a single chain in which the plurality of nano graphene-metal fused materials are sequentially connected, or in the form of a composite chain in which the plurality of nano graphene-metal fused materials are irregularly connected.

In the method of preparing a graphene-substrate composite using the graphene-graphene fused material according to the above-described second feature, the thermal treating of the graphene-metal fused material is preferably conducted at a temperature higher than a melting point of the nano metal.

In the method of preparing a graphene-substrate composite using the graphene-graphene fused material according to the above-described second feature, the nano metal is preferably any one of nickel, copper and silver.

In the method of preparing a graphene-substrate composite using the graphene-graphene fused material according to the above-described second feature, the substrate is preferably formed of any one of a polymer, an organic material, a metal and an inorganic material.

In another aspect of the present invention, the present invention provides a graphene-graphene fused material which is prepared by the method of preparing a graphene-graphene fused material and in which a plurality of graphenes are connected to each other by a melting bonding of a nano metal.

In another aspect of the present invention, the present invention provides a graphene-substrate composite which is prepared by the method of preparing a graphene-substrate composite, and in which a graphene-graphene fused material powder is dispersed in a substrate.

### BRIEF DESCRIPTION OF THE DRAWINGS

The above and other aspects will be more clearly understood from the following detailed description taken in conjunction with the accompanying drawings, in which:

FIG. 1 is a structural view illustrating a 2-dimensional nanosheet made of single graphene layers.

FIG. 2 is a schematic view illustrating that various kinds of functional groups, such as COOH, COO, OH, NH, or the like are formed on corners of nano graphene.

FIG. 3 is a flow diagram sequentially showing a method of preparing a graphene-substrate composite according to a preferred embodiment of the present invention.

FIG. 4 is a schematic view illustrating a nano graphene-metal fused material and a melted and bonded state of nano graphene and nano metal in a method of preparing a graphene-graphene fused material according to a preferred embodiment of the present invention.

FIG. 5 is a schematic view illustrating a graphene-graphene fused material prepared by a method of preparing a graphene-graphene fused material according to a preferred embodiment of the present invention. FIG. 5A illustrates a nano graphene-graphene fused material in the form of a single chain, and FIG. 5B illustrates a nano graphene-graphene fused material in the form of a composite chain.

FIG. 6 is a schematic view illustrating a graphene-substrate composite prepared by a method of preparing a graphene-substrate composite according to a preferred embodiment of the present invention. FIG. 6A illustrates that a graphene-graphene fused material in the form of a single chain is dispersed in a polymer substrate, and FIG. 6B illustrates that a graphene-graphene fused material is dispersed in a polymer substrate.

FIG. 7 is a scanning electron microscopic (SEM) photograph of an example of a nano graphene-metal fused material in a method of preparing a graphene-graphene fused material according to a preferred embodiment of the present invention.

FIG. 8 shows X-ray diffraction (XRD) analysis results of exemplary nano graphene-metal fused materials in a method of preparing a graphene-graphene fused material according to a preferred embodiment of the present invention, in which nano graphene and nickel are successfully fused in an RF plasma system. FIG. 8A shows an XRD analysis result (of nano graphene-nickel mixture) before an RF plasma treatment, and FIG. 8B shows an XRD result (of nano graphene-nickel fused material) after an RF plasma treatment.

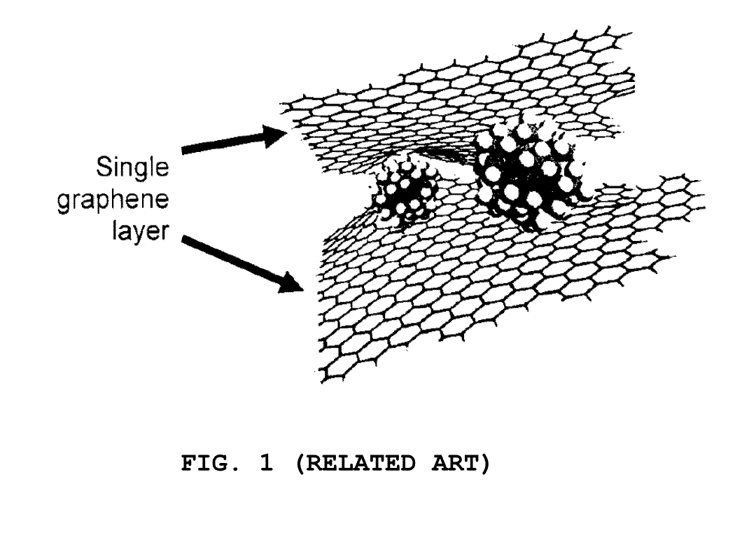

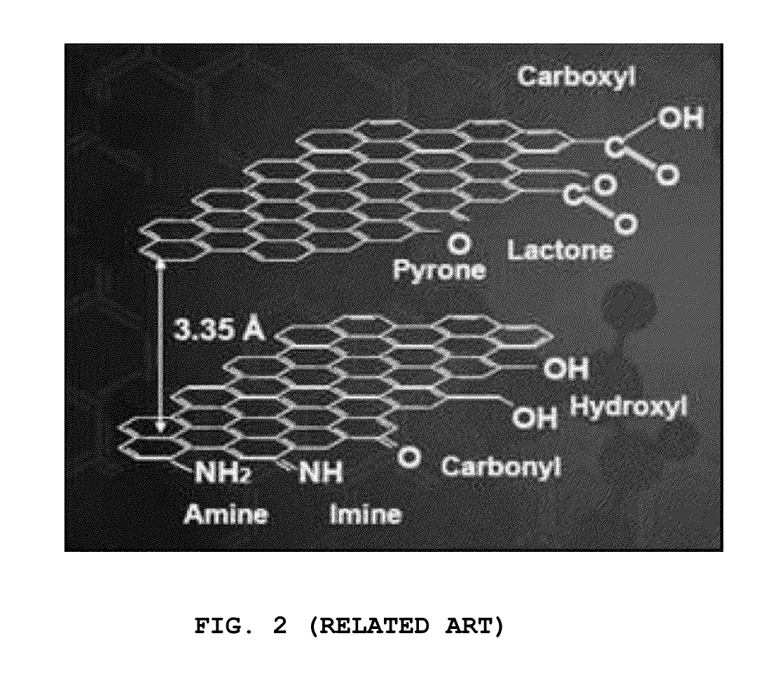

### DETAILED DESCRIPTION

Hereinafter, methods of preparing a graphene composite according to preferred embodiments of the present invention will be described with reference to the accompanying drawings. A method of preparing a graphene composite according to the present invention is characterized in that a graphene-metal fused material is first prepared and is then pulverized and dispersed in a solvent to prepare a graphene composite.

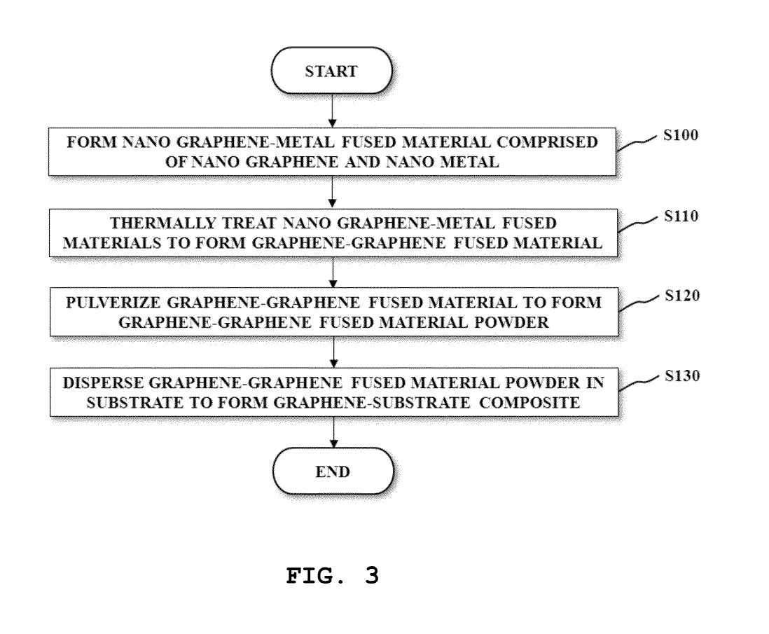

FIG. 3 is a flow diagram sequentially showing a method of preparing a graphene-substrate composite according to a preferred embodiment of the present invention.

Referring to FIG. 3, a method of preparing a graphene composite according to the present invention includes forming (S100) a nano graphene-metal fused material comprised of nano-graphene and nano metal, thermally treating (S110) the plurality of nano graphene-metal fused materials to connect the plurality of nano graphene-metal fused materials to each other by a melting bonding of the nano metal to form a graphene-graphene fused material, pulverizing (S120) the graphene-graphene fused material to form a graphene-graphene fused material powder, and dispersing (S130) the graphene-graphene fused material powder in a substrate to form a graphene-substrate composite. Hereinafter, respective operations constituting the above-described method of preparing a graphene composite will be described in detail.

In operation 100, by coating or attaching nano metal particles on a surface of nano graphene, a nano graphene-metal fused material comprised of nano graphene and nano metal is formed. The process of coating or attaching the nano metal particles on the surface of the nano graphene may be conducted by using an RF plasma process or a wet process well known in the art.

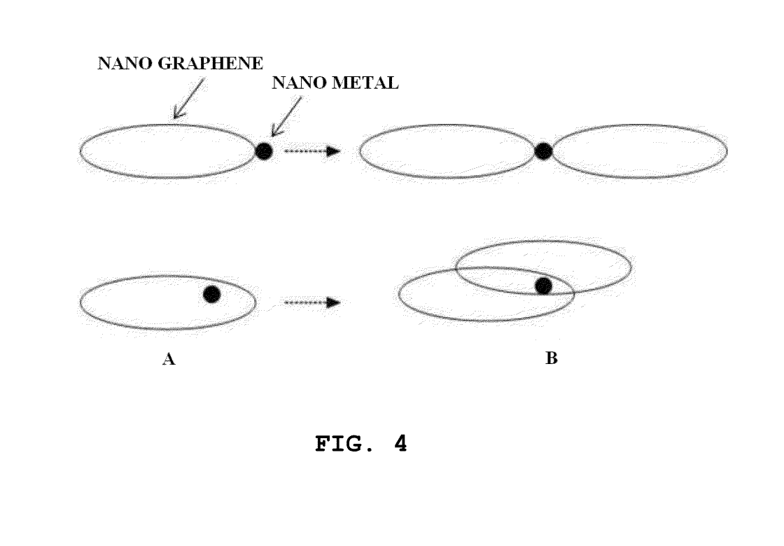

FIG. 4 is a schematic view illustrating a nano graphene-metal fused material and a melted and bonded state of nano graphene and nano metal in a method of preparing a graphene-graphene fused material according to a preferred embodiment of the present invention. FIG. 4A illustrates a nano graphene-metal fused material, and FIG. 4B illustrates a graphene-metal fused material in which the nano metal of the nano graphene-metal fused material is melted and attached.

The nano graphene has a nano sized thickness, and length and width in a range of 1-100 μm. The nano metal indicates a metal having a diameter not greater than about 50 μm, and may be nickel, copper or silver in the present invention.

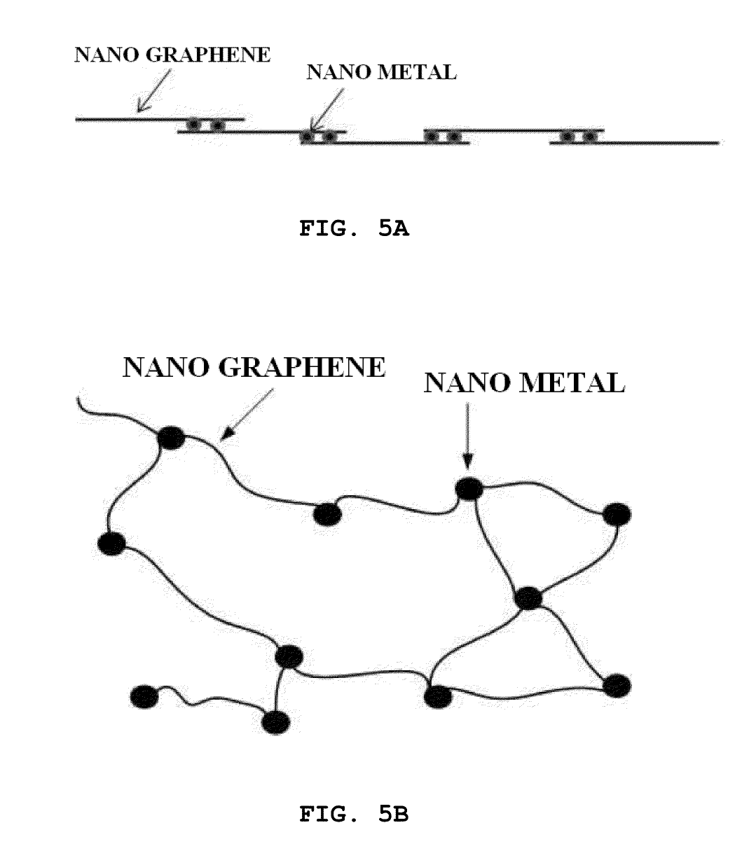

In operation 110, the plurality of nano graphene-metal fused materials are thermally treated at a temperature higher than a melting point of the nano metal such that the nano metal is melted and attached, thereby forming a graphene-graphene fused material in which the plurality of nano graphene-metal fused materials are connected in the form of a single long chain or in the form of a composite chain in which single chains are irregularly connected. FIG. 5 is a schematic view illustrating a graphene-graphene fused material prepared by a method of preparing a graphene-graphene fused material according to a preferred embodiment of the present invention. FIG. 5A illustrates a nano graphene-graphene fused material in the form of a single chain, and FIG. 5B illustrates a nano graphene-graphene fused material in the form of a composite chain.

The thermal treatment for forming the graphene-graphene fused material may be conducted by heating the nano graphene-metal fused materials at a temperature higher than the melting point of the nano metal by using an RF heating or hot wind such that the nano metal between the nano graphene fused materials is melted and attached to the nano graphene fused materials.

In this regard, by applying a pressure to the nano graphene-metal fused materials simultaneously with the thermal treatment, the plurality of nano graphene-metal fused materials may be connected in the form of a single long chain by a melting bonding, or by blowing hot wind to the nano graphene-metal fused materials without applying a pressure, the plurality of nano graphene-metal fused materials may be connected in the form of an irregular composite chain by a melting bonding.

In operation 120, the graphene-graphene fused material is pulverized to form a graphene-graphene fused material powder. The graphene-graphene fused material powder formed by the pulverization may maintain the form of a single chain or a composite chain by the melting bonding between the plurality of nano graphene-metal fused materials.

In operation 130, the graphene-graphene fused material powder is dispersed in a substrate to form a graphene composite martial. The substrate may be formed of any one of polymer, an organic material, a metal and an inorganic material. By putting the graphene-metal fused material powder in a solution or melt of the substrate and mixing the graphene-metal fused material powder with the solution or melt of the substrate, a graphene-substrate composite in which the graphene-graphene fused material powder is dispersed in the substrate may be formed, and particularly by dispersing the graphene-graphene fused material powder in a polymer, such as polyethylene terephthalate (PET), polyethylene naphtalate (PEN), polycarbonate (PC), polyether sulfone (PES), polyimide (PI), a graphene/polymer composite having superior performances in electrical conductivity and the like may be formed.

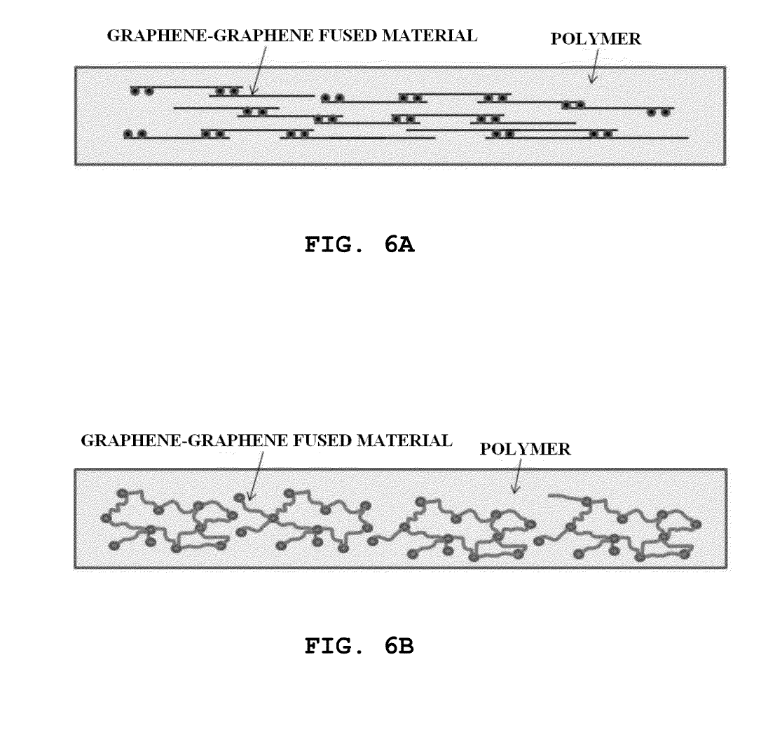

FIG. 6 is a schematic view illustrating a graphene-substrate composite prepared by a method of preparing a graphene-substrate composite according to a preferred embodiment of the present invention. FIG. 6A illustrates that a graphene-graphene fused material in the form of a single chain is dispersed in a polymer substrate, and FIG. 6B illustrates that a graphene-graphene fused material is dispersed in a polymer substrate. Since the graphene-graphene fused materials dispersed in the graphene-substrate composite are connected in the form of a single chain or composite chain, the graphene-graphene fused materials have superior electrical conductivity and superior heat conductivity, and function as a good gas barrier.

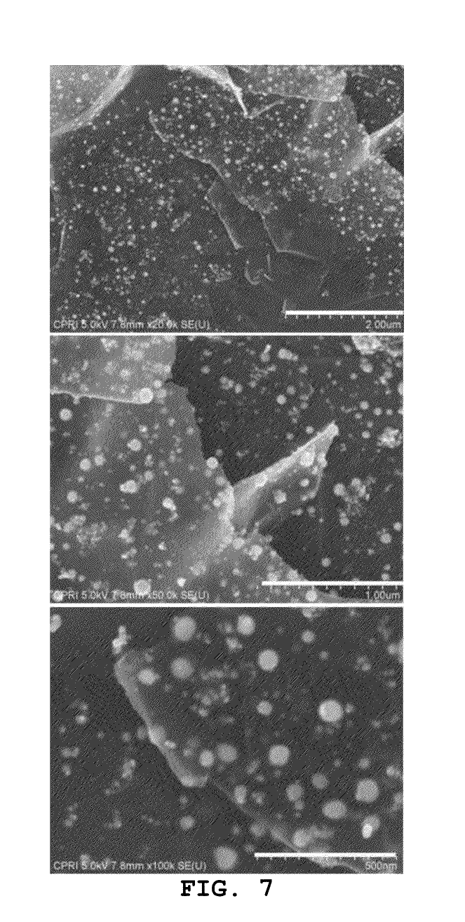

FIG. 7 is a scanning electron microscopic (SEM) photograph of an example of a nano graphene-metal fused material in a method of preparing a graphene-graphene fused material according to a preferred embodiment of the present invention. A nano graphene-nickel fused material in which nano graphene and nano nickel are fused by using RF plasma was photographed by a scanning electron microscope (SEM). It can be seen from the SEM photograph that nano nickel was nucleated on the graphene.

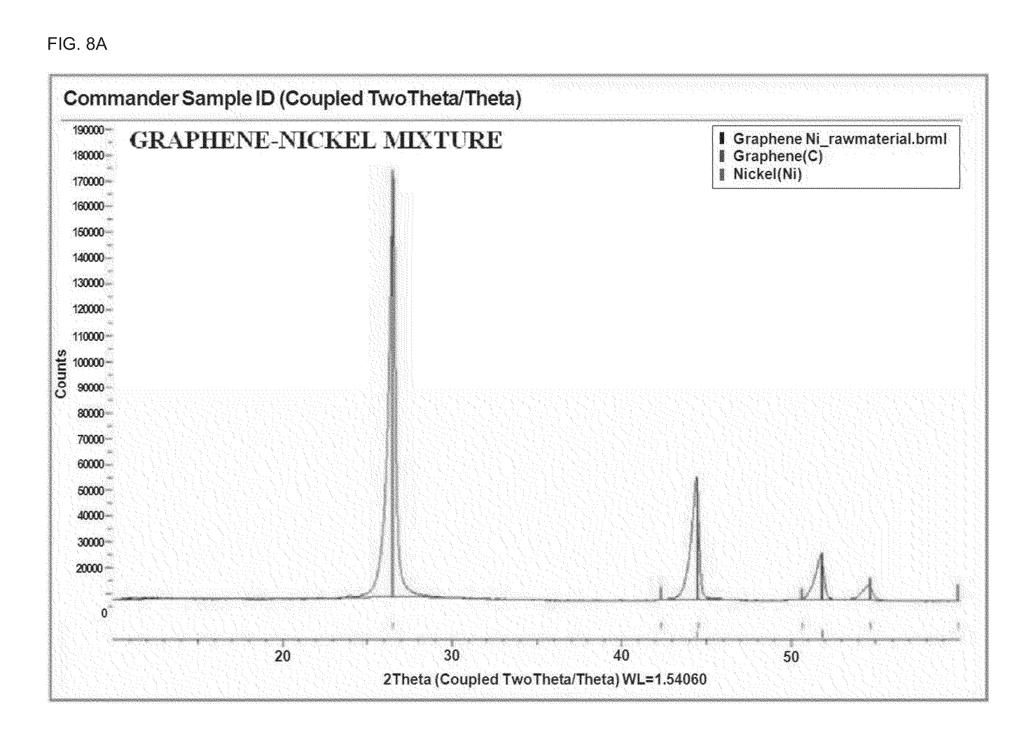

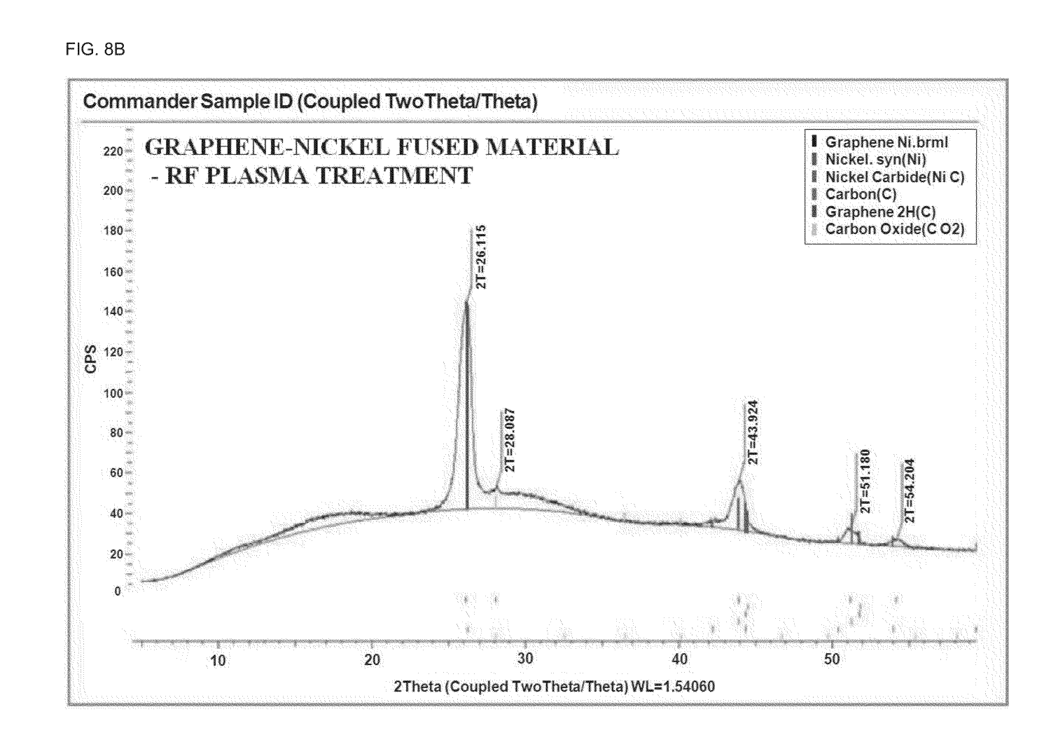

FIG. 8 shows X-ray diffraction (XRD) analysis results of exemplary nano graphene-metal fused materials in a method of preparing a graphene-graphene fused material according to a preferred embodiment of the present invention, in which nano graphene and nickel are successfully fused in an RF plasma system. FIG. 8A shows an XRD analysis result (of nano graphene-nickel mixture) before an RF plasma treatment, and FIG. 8B shows an XRD result (of nano graphene-nickel fused material) after an RF plasma treatment. The XRD data shows that the graphene and nickel are not physically but chemically bonded.

A graphene-substrate composite using a nano graphene-graphene fused material according to the present invention may be widely used as a material of a flexible substrate as well as an electrode material of lithium secondary battery and ultra high capacity capacitor. In particular, compared with the existing graphene composites, the graphene composite according to the present invention may have superior performances in electrical conductivity, heat conductivity, gas barrier and the like.

By the method of preparing a nano graphene-graphene fused material according to the present invention, graphene and graphene may be connected to each other by a simple process to prepare a graphene-graphene fused material having superior performances in electrical conductivity, heat conductivity, gas barrier and the like.

Also, by the method of preparing a graphene-substrate composite according to the present invention, a graphene-graphene fused material is pulverized and then dispersed in a substrate solution to prepare a graphene-substrate composite having superior performances in electrical conductivity, heat conductivity, gas barrier, and the like.

Although the detailed description has been disclosed for illustrative purposes, those skilled in the art will appreciate that various modifications, additions and substitutions are possible, without departing from the scope and spirit of the inventive concept as disclosed in the accompanying claims.

1. A method of preparing a graphene-graphene fused material, the method comprising:
(a) forming a nano-graphene-metal fused material comprised of nano-graphene and nano-metal; and
(b) thermally treating the plurality of nano graphene-metal fused materials to connect the plurality of nano graphene-metal fused materials to each other by a melting bonding of the nano metal to form a graphene-graphene fused material.

2. The method of claim 1, wherein the nano graphene-metal fused material is formed by coating or attaching a nano metal particle on a surface of the nano graphene.

3. The method of claim 1, wherein the graphene-graphene fused material is configured in the form of a single chain in which the plurality of nano graphene-metal fused materials are sequentially connected, or in the form of a composite chain in which the plurality of nano graphene-metal fused materials are irregularly connected.

4. The method of claim 1, wherein the thermal treating of the nano graphene-metal fused materials is conducted at a temperature higher than a melting point of the nano metal.

5. The method of claim 1, wherein the nano metal is any one of nickel, copper and silver.

6. A method of preparing a graphene-substrate composite, the method comprising:
(a) forming a nano-graphene-metal fused material comprised of nano-graphene and nano-metal;
(b) thermally treating the plurality of nano graphene-metal fused materials to connect the plurality of nano graphene-metal fused materials to each other by a melting bonding of the nano metal to form a graphene-graphene fused material;
(c) pulverizing the graphene-graphene fused material to form a graphene-graphene fused material powder; and
(d) dispersing the graphene-graphene fused material powder in a substrate to form a graphene-substrate composite.

7. The method of claim 6, wherein the nano graphene-metal fused material is formed by coating or attaching a nano metal particle on a surface of the nano graphene.

8. The method of claim 6, wherein the graphene-graphene fused material is configured in the form of a single chain in which the plurality of nano graphene-metal fused materials are sequentially connected, or in the form of a composite chain in which the plurality of nano graphene-metal fused materials are irregularly connected.

9. The method of claim 6, wherein the thermal treating of the nano graphene-metal fused materials is conducted at a temperature higher than a melting point of the nano metal.

10. The method of claim 6, wherein the substrate is any one of polymer, an organic material, a metal, and an inorganic material.

11. A graphene-graphene fused material prepared by the method of claim 1, wherein a plurality of graphenes are connected to each other by a melting bonding of a nano metal.

12. A graphene-substrate composite prepared by the method of claim 1, wherein a graphene-graphene fused material powder is dispersed in a substrate.
